(19) United States
(12) Patent Application Publication
(10) Pub. No.: US 2016/0371995 A1
(43) Pub. Date: Dec. 22, 2016

(54) EDUCATIONAL SOFTWARE FOR ASSESSING A CHILD'S DEVELOPMENTAL STAGE AND INTERESTS AND RECOMMENDING AND DELIVERING EDUCATIONAL TOYS AND GAMES BASED ON THE SPECIFIC NEEDS OF THE CHILD

(71) Applicants: Amit RIKHI, Newcastle, WA (US); Melissa DREYER, Atlanta, GA (US)

(72) Inventors: Amit RIKHI, Newcastle, WA (US); Melissa DREYER, Atlanta, GA (US)

(21) Appl. No.: 15/185,703

(22) Filed: Jun. 17, 2016

Related U.S. Application Data
(60) Provisional application No. 62/182,027, filed on Jun. 19, 2015.

(51) Int. Cl. G09B 5/12; H04L 29/08

(52) U.S. Cl. CPC G09B 5/125; H04L 67/02; G06Q 50/20

(57) ABSTRACT

A software implemented system and method for selecting a developmentally appropriate children's toy and providing a customized online lesson to accompany the toy are described. With this invention, parents can access a website that will assess their child's development level and personal preferences to select a toy that will be appealing to the child while also being developmentally appropriate. The chosen toy will be accompanied by an electronic lesson or game that will also be customized to the specific child's development and preferences.

The present disclosure relates to a system for educating children including a computer system that executes a software system that measures a child's particular level of development, uses that information to select an appropriate educational toy, recommends that educational toy, and provides an accompanying software lesson associated with the toy.

### BACKGROUND

Today, households will often have a single parent, two working spouses, or other issues that place a premium on the time of parents. Trying to balance work, life, and family can make anyone feel rushed. Parents may express that technology such as smart phones, E-commerce and educational apps have made their lives easier. If asked however, those same people will likely say that the technology that can make life easier can be overwhelming with all the choices available. There are multiple apps for everything now and selecting the best products is difficult enough, but the difficulties are compounded when trying to decide what are the right and wrong educational toys for your child. Is your selection exposing your child to something that they are not developmentally ready for? Is the toy you are buying the best that is available on the market?

The increased access to technology and educational product options has made it challenging for today's parent to effectively assess educational toys and games that are the right fit for their children. This becomes increasingly critical knowing that 90% of a child's brain development happens before age five, yet fewer than three in ten 4-year-olds are enrolled in a high-quality preschool program.

The invention described herein provides parents with a simple and effective tool to customize the selection of educational products based upon the development, skills and preferences of their individual child.

### BRIEF DESCRIPTION OF THE DRAWINGS

FIG. 1 illustrates how a user might interact with the product.

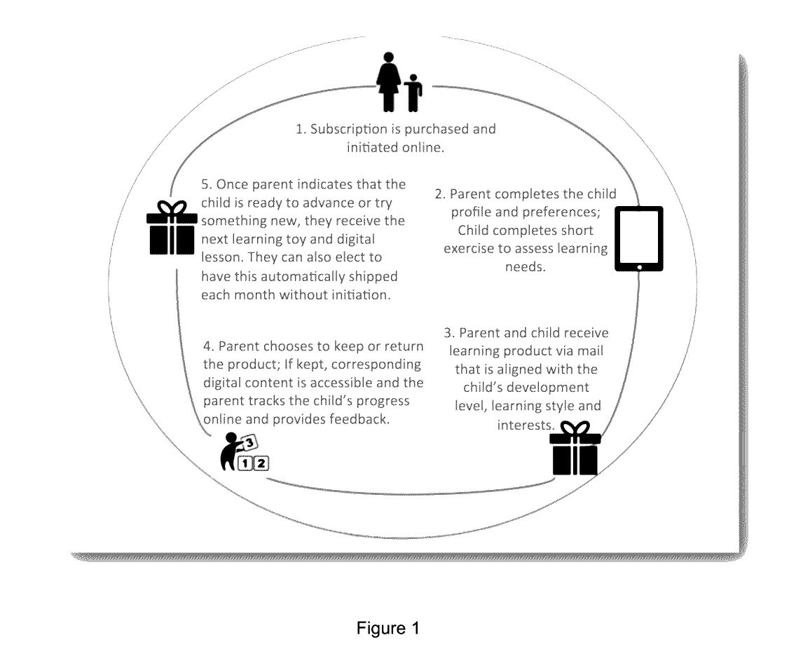

FIG. 2 illustrates one embodiment of a user interface.

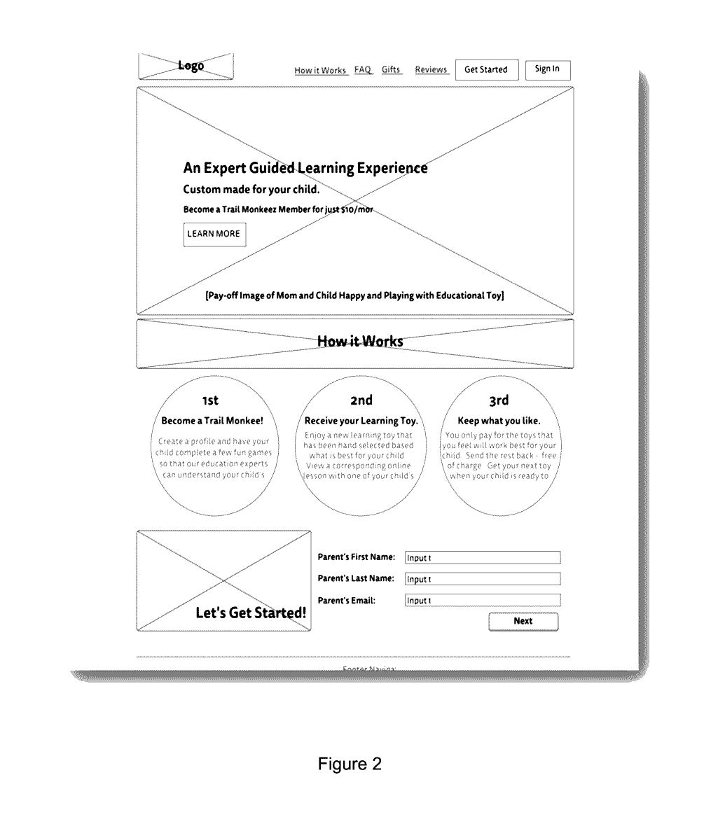

FIG. 3 illustrates one embodiment of a distribution model.

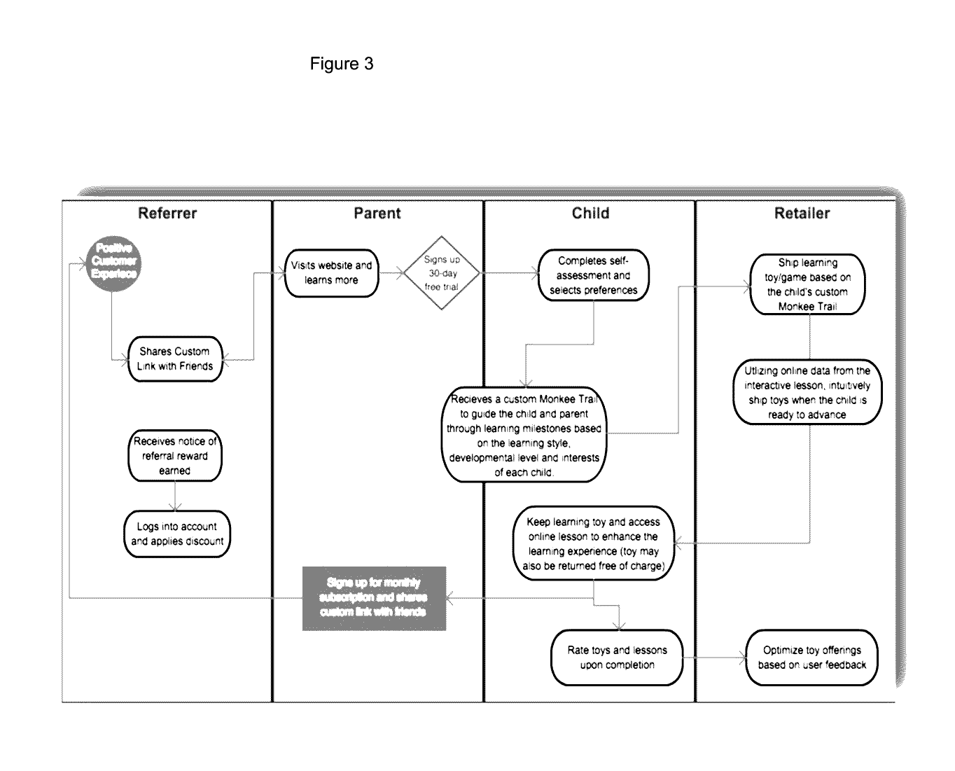

### DESCRIPTION

The following discussion is directed to various embodiments of the invention. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed below may be employed separately or in any suitable combination to produce desired results. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not structure or function.

As used in the following discussion and in the claims, the terms “including,” “comprising,” “containing,” “is,” etc. are used in an open-ended fashion, and thus should be interpreted to mean “including, but not limited to.” If closed language is included, “consisting,” and “consisting essentially of,” it will be given its art recognized meaning.

As used in the following discussion and in the claims, the terms “educational toy,” “toy,” and “developmentally appropriate toy” are used interchangeably and refer to a plaything that can be physical toy or game or other amusement or can be a computer based toy or game or other amusement.

As used in the following discussion and in the claims, the terms “exercises,” “evaluations,” are used interchangeably and refer to games, materials, questions, or other tools of inquiry that provide information upon which assessment of the user can be based. The term “game” can either be an exercise or evaluation tool of can be a toy depending upon the context. In some instances “game” can refer to something which is both a toy and an exercise or evaluation tool.

As used in the following discussion and in the claims, the terms “lesson,” refers to any material that has the capability of teaching. Lesson can refer to a traditional educational style lesson, or it can be material presented in a wide variety of other forms including games, videos, audio tracks, podcasts, webinars, or other delivery platforms.

As used in the following discussion and in the claims, the terms “developmentally appropriate” refers to materials that comport with one or more of the capabilities of the user.

The present disclosure relates to a system for selecting developmentally appropriate educational toys for children. According to one embodiment, the system comprises a website hosted over an appropriate network that may be accessed by a computer or handheld device. Appropriate hardware for hosting a website and for accessing the website over an appropriate network is well understood by the skilled artisan. Any art recognized hardware system may be employed.

According to one embodiment, the disclosure describes a computer-implemented method to select an educational toy, that comprises generating, from a storage resource and processor communicatively coupled to the storage resource, an exercise or game to assess the development of a user; receiving, by an application executing on a user network device associated with a user, the outputs of the exercise or game; processing the outputs to select an educational toy appropriate to the development of the user; and generating from the outputs and the selection of the toy, a lesson to accompany the toy to the user.

According to another embodiment, the disclosure describes a system for selecting an educational toy for a child that comprises a storage resource; and a processor communicatively coupled to the storage resource, wherein the processor executes application code instructions that are stored in the storage resource and that cause the system to; send to a user's network device a series of games or evaluations, receive input from the user's device with the generated responses to the games or evaluation, process the generated responses to ascertain the user's development and select an appropriate educational toy, send to the user's network device an electronic lesson that is generated based upon the generated responses and the selection of the educational toy.

According to yet another embodiment, the disclosure describes a system for educating a child that comprises a storage resource comprising application code instructing the system to send evaluation material to a user's network device, receive input from the user's device; process the user input to select a toy and educational software for the user, a processor communicatively coupled to the storage resource, wherein the processor executes the application code, a user network device capable of receiving the evaluation material from the system; sending user input to the system, and receiving educational software.

The present disclosure describes a system capable of providing to a user development assessment materials, receiving input from the user in response to the development assessment materials, determining an appropriate educational toy based upon the development assessment input; and providing to the user educational materials appropriate for the educational toy. The present disclosure further describes a method whereby a user inputs information in response to developmental questions or games; the input is used to select an appropriate educational toy; and the toy is provided to the user. According to one embodiment, the toy is accompanied by additional developmental questions or games that are used to further evaluate the user. According to another embodiment, the system provides a developmental game in place of the educational toy.

One embodiment as described may be implemented using a computer system or processor. The system as described can be implemented on a number of devices, for example, the system may include a memory device for storing a set of instructions and processor hardware for executing those instructions. The system for recommending education toys may further comprise one or more servers, computers, or hand held devices to store and implement software instructions consistent with the disclosed embodiments.

The software product may define functions of the exemplary embodiments (which may include methods) described herein and can be contained on a variety of computer readable media. Illustrative computer readable media include, without limitation, (i) information permanently stored on non-writable storage media (e.g., read-only memory devices within a computer such as CD-ROM disks readable by a CD-ROM drive); (ii) alterable information stored on writable storage media (e.g., computer disks for use with a disk drive or hard-disk drive, writable CD-ROM disks and DVD disks, zip disks, portable memory devices, and any other device configured to store digital data); and (iii) information conveyed across communications media, (e.g., a computer, telephone, wired network or wireless network). These embodiments may include information shared over the Internet or other computer networks. Such computer readable media, when carrying computer-readable instructions that perform methods of the invention, may represent embodiments as described.

Further software routines or modules that implement embodiments of the invention may be part of an operating system or part of a specific application, component program, module, object, or sequence of instructions, such as an executable script. Such software routines typically include a plurality of instructions capable of being performed using a computer system or other type or processor configured to execute instructions from a computer readable medium. Also, programs typically include or interface with variables, data structures, etc., that reside in a memory or on storage devices as part of their operation. In addition, various programs described herein may be identified based upon the application for which they are implemented. Those skilled in the art will readily recognize, however, that any particular nomenclature or specific application that follows facilitates a description of the invention and does not limit the invention for use solely with a specific application or nomenclature. Furthermore, the functionality of programs described herein may use a combination of discrete modules or components interacting with one another. Those skilled in the art will recognize, however, that different embodiments may combine or merge such components and modules in a variety of ways.

According to one embodiment, the system can include one or more mobile devices and the system can be implemented as a mobile APP. The APP can include an interface to display information, for example, to a child, receive information from the child, and display information in response to the child's input.

According to one embodiment, the system assesses the child's current development stage through the use of interactive games. The interactive games can be any art recognized educational games or newly developed proprietary games that will provide an assessment of the child's development. The assessment may be done using any art recognized electronic device that will capture the child's responses. For example, the device may be a smart phone, a tablet, a laptop computer and the like. The assessment may be carried out on any device that is connected to the internet. The assessment may be done directly on the software system, via a website or it may be conducted in one or more APPs that are loaded to a tablet or phone.

Once the assessment is complete, the software system uses an algorithm to select an appropriate educational toy based upon the child's assessment. According to one embodiment, the assessment of the child includes capturing information regarding the child's preferences and interests, including for example, favorite song, favorite color, favorite character, favorite movie, favorite sport, etc. Along with the developmental assessment, this information can be used to select a developmentally appropriate educational toy in line with the child's interests. According to one embodiment, feedback will be solicited from the child's parents and used in subsequent iterations of the toy selections to further optimize the selection of an appropriate toy for the individual child.

According to one embodiment, the selected toy may be sent to the child accompanied by a customized electronic lesson featuring the child's preferences. The electronic lesson may be delivered by any appropriate method including readable media, but in most cases will be supplied via a wired or wireless connection to a website or a connection to an associated APP.

The lesson may be customized to use the child's favorite music, colors or characters. The lesson can be customized to generate specific content appropriate for your specific child based upon the specific individual outcomes of the assessment tests. According to one example, the child is assessed as having a good grasp on his numbers, but not as good a grasp on his letters. His lesson might include games or exercises that involve letters. By contrast, the lesson for a similarly situated child with less number proficiency might find his lesson to have more number games or exercises. In both examples, the online lesson will correspond with the toy they receive.

According to one embodiment, the system includes a website that will provide a user dashboard that allows a user to manage their account, make payments, request reassessment of their child, change their passwords, preferences and the like. According to one embodiment, the child can be reassessed at any time by the parent requesting re-assessment. According to another embodiment, the child may be constantly reassessed by continuing to play assessment games that can be found on the website or in an APP.

The software system as described may be run on one or more servers, either actual or cloudbased. The software system will include a module for assessing the development of the child, a module for obtaining the child's preferences, a module for selecting an appropriate toy, a module for developing the accompanying lesson and a module for allowing the child to interact with the accompanying lesson.

According to one embodiment of the described software system, the parent would receive a new educational toy at a selected interval that may be kept or sent back. According to another embodiment, the parent (or other account holder) will pay a subscription fee that allows them to order a new educational toy at any time from their dashboard. According to this subscription embodiment, the account holder might also receive a new educational toy at given intervals, e.g. once a month.

Other embodiments of the present invention can include alternative variations. These and other variations and modifications will become apparent to those skilled in the art once the above disclosure is fully appreciated. It is intended that the following claims be interpreted to embrace all such variations and modifications.

We claim:

1. A computer-implemented method to select an educational toy, comprising:
generating, from a storage resource and processor communicatively coupled to the storage resource, an exercise or game to assess the development of a user;
receiving, by an application executing on a user network device associated with a user, the outputs of the exercise or game;
processing the outputs to select an educational toy appropriate to the development of the user; and
generating from the outputs and the selection of the toy, a lesson to accompany the toy to the user.

2. The computer-implemented method of claim 1, further comprising:
sending the selected toy to the address of the user.

3. The computer-implemented method of claim 1, wherein the storage resource takes the form of a website.

4. The computer-implemented method of claim 1, wherein the storage resource takes the form of an APP.

5. The computer-implemented method of claim 1, wherein the user network device is a computer, laptop, PDA or other handheld device.

6. A system for selecting an educational toy for a child comprising:
a storage resource; and a processor communicatively coupled to the storage resource, wherein the processor executes application code instructions that are stored in the storage resource and that cause the system to:
send to a user's network device a series of games or evaluations;
receive input from the user's device with the generated responses to the games or evaluation;
process the generated responses to ascertain the user's development and select an appropriate educational toy;
send to the user's network device an electronic lesson that is generated based upon the generated responses and the selection of the educational toy.

7. The system of claim 7, wherein the educational toy is delivered to the user's address.

8. The system of claim 7, wherein the storage resource takes the form of a website.

9. The system of claim 7, wherein the storage resource takes the form of an APP.

10. The system of claim 7, wherein the user network device is a computer, laptop, PDA or other handheld device.

11. A system for educating a child comprising:
a storage resource comprising application code instructing the system to send evaluation material to a user's network device, receive input from the user's device; process the user input to select a toy and educational software for the user;
a processor communicatively coupled to the storage resource, wherein the processor executes the application code;
a user network device capable of receiving the evaluation material from the system; sending user input to the system, and receiving educational software.

12. The system of claim 11, wherein the educational toy is delivered to the user's address.

13. The system of claim 11, wherein the storage resource takes the form of a website.

14. The system of claim 11, wherein the storage resource takes the form of an APP.

15. The system of claim 11, wherein the user network device is a computer, laptop, PDA or other handheld device.
